(19) United States
(12) Patent Application Publication
(10) Pub. No.: US 2024/0413768 A1
(43) Pub. Date: Dec. 12, 2024

(54) DRIVE CIRCUIT FOR AN ULTRASONIC MOTOR

(71) Applicant: Seagate Technology LLC, Fremont, CA (US)

(72) Inventor: WenJun Cao, Shugart (SG)

(21) Appl. No.: 18/740,661

(22) Filed: Jun. 12, 2024

Related U.S. Application Data
(60) Provisional application No. 63/507,552, filed on Jun. 12, 2023.

(51) Int. Cl. H02N 2/14; G11B 19/20

(52) U.S. Cl. CPC H02N 2/147; G11B 19/2009

(57) ABSTRACT

A device includes a first set of switches and a second set of switches; a first filter and a second filter each comprising an unfiltered terminal and a filtered terminal; and a first piezoelectric element and a second piezoelectric element each comprising a first contact and a second contact. Turning on the first set of switches and turning off the second set of switches applies a first driving voltage to the first piezoelectric element and applies a second driving voltage to the second piezoelectric element.

### CROSS REFERENCE TO RELATED APPLICATIONS

This application claims the benefit of U.S. Provisional Application 63/507,552, filed Jun. 12, 2023, the disclosure of which is incorporated by reference herein in its entirety.

### TECHNICAL FIELD

The disclosure relates to a drive circuit for an ultrasonic motor.

### BACKGROUND

Ultrasonic motors (USM) are a type of motor that operate applying time-dependent voltages (e.g., input or voltage source waveforms) to piezoelectric elements to manipulate the physical dimensions of the piezoelectric elements in periodic form and induce movement between the USM and an adjacent surface (e.g., a rotor, a track). Ultrasonic motors may provide specific advantages over other motor technologies such as electromagnetic motors. Some of these advantages may include positioning speed, precision, and accuracy; size and weight; power efficiency, and motor noise. Additionally, because USMs operate using piezoelectric elements, they do not produce magnetic fields and may be suitable to applications that are sensitive to magnetic fields, such as hard disk drives (HDDs).

Some USMs operate by applying voltage waveforms to one or more piezoelectric elements to induce periodic expansion and contraction of the element(s). Placing the element(s) or an intervening feature of the USM (e.g., a protruding contact feature coupled to a piezoelectric element of the USM) in contact with a surface of a motor component such as a rotor or a linear track may enable the periodic expansion and contraction of the piezoelectric element(s) to induce a relative movement between the piezoelectric element(s) and the motor component. A typical USM utilizes multiple drive circuits to apply voltage waveforms to different piezoelectric elements of the USM.

### SUMMARY

The present disclosure describes a drive circuit for an ultrasonic motor (USM). An example drive circuit of this disclosure is configured to apply distinct driving voltage waveforms to multiple piezoelectric elements of the USM, with the driving voltage waveforms derived from a single source voltage waveform (e.g., a square waveform). Providing a single drive circuit to manipulate multiple piezoelectric elements by applying distinct voltage waveforms to those piezoelectric elements may provide a cost advantage over drive circuits that are configured to manipulate single piezoelectric elements. Additionally, an example drive circuit of this disclosure includes filters (e.g., low-pass filters) that are configured to remove high order harmonies from the generated driving voltage waveforms. Removing high order harmonies from the driving voltage waveforms may improve tracking performance of the USM by reducing issues such as servo loops due to aliasing.

In one example, a device includes a voltage source including a first voltage source terminal and a second voltage source terminal; a first set of switches and a second set of switches; a first filter and a second filter each including an unfiltered terminal and a filtered terminal; and a first piezoelectric element and a second piezoelectric element each including a first contact and a second contact, wherein the filtered terminal of the first filter is coupled to the first contact of the first piezoelectric element and the first contact of the second piezoelectric element, wherein the filtered terminal of the second filter is coupled to the second contact of the second piezoelectric element, and wherein turning on the first set of switches and turning off the second set of switches couples the first voltage source terminal to the unfiltered terminal of the first filter, produces a first filtered voltage at the filtered terminal of the first filter, couples the second voltage source terminal to the second contact of the first piezoelectric element and to the unfiltered terminal of the second filter, produces a second filtered voltage at the filtered terminal of the second filter, applies a first driving voltage to the first piezoelectric element, and applies a second driving voltage to the second piezoelectric element.

In another example, a drive circuit for an ultrasonic motor includes a voltage source including a first voltage source terminal and a second voltage source terminal; a first set of switches and a second set of switches; a first filter and a second filter each including an unfiltered terminal and a filtered terminal; and a first piezoelectric element and a second piezoelectric element each including a first contact and a second contact, wherein the filtered terminal of the first filter is coupled to the first contact of the first piezoelectric element and the first contact of the second piezoelectric element, wherein the filtered terminal of the second filter is coupled to the second contact of the second piezoelectric element, and wherein turning on the first set of switches and turning off the second set of switches couples the first voltage source terminal to the unfiltered terminal of the first filter, produces a first filtered voltage at the filtered terminal of the first filter, couples the second voltage source terminal to the second contact of the first piezoelectric element and to the unfiltered terminal of the second filter, produces a second filtered voltage at the filtered terminal of the second filter, applies a first driving voltage to the first piezoelectric element, and applies a second driving voltage to the second piezoelectric element.

In another example, a method includes the steps of providing a first filter and a second filter each including an unfiltered terminal and a filtered terminal; providing a first piezoelectric element and a second piezoelectric element each including a first contact and a second contact; coupling the filtered terminal of the first filter to the first contact of the first piezoelectric element and the first contact of the second piezoelectric element; coupling the filtered terminal of the second filter to the second contact of the second piezoelectric element; applying, between a first voltage source terminal and a second voltage source terminal of a voltage source, a time-dependent source voltage including a source voltage waveform; and coupling, by turning on a first set of switches and turning off a second set of switches, the first voltage source terminal to the unfiltered terminal of the first filter, and the second voltage source terminal to the second contact of the first piezoelectric element and to the unfiltered terminal of the second filter.

These and other features and aspects of various examples may be understood in view of the following detailed discussion and accompanying drawings.

### BRIEF DESCRIPTION OF THE DRAWINGS

FIG. 1 is a perspective view of an example ultrasonic motor, in accordance with aspects of this disclosure.

FIG. 2A is a circuit diagram illustrating an example drive circuit for an ultrasonic motor, in accordance with aspects of this disclosure.

FIG. 2B is a circuit diagram illustrating an example drive circuit for an ultrasonic motor, in accordance with aspects of this disclosure.

FIG. 3 is plot of a source voltage waveform and driving voltage waveforms of drive circuit for an ultrasonic motor, in accordance with aspects of this disclosure.

FIG. 4 is a flow diagram illustrating a method for driving an ultrasonic motor, in accordance with aspects of this disclosure.

FIG. 5 is a perspective view of an example hard disk drive, in accordance with aspects of this disclosure.

### DETAILED DESCRIPTION

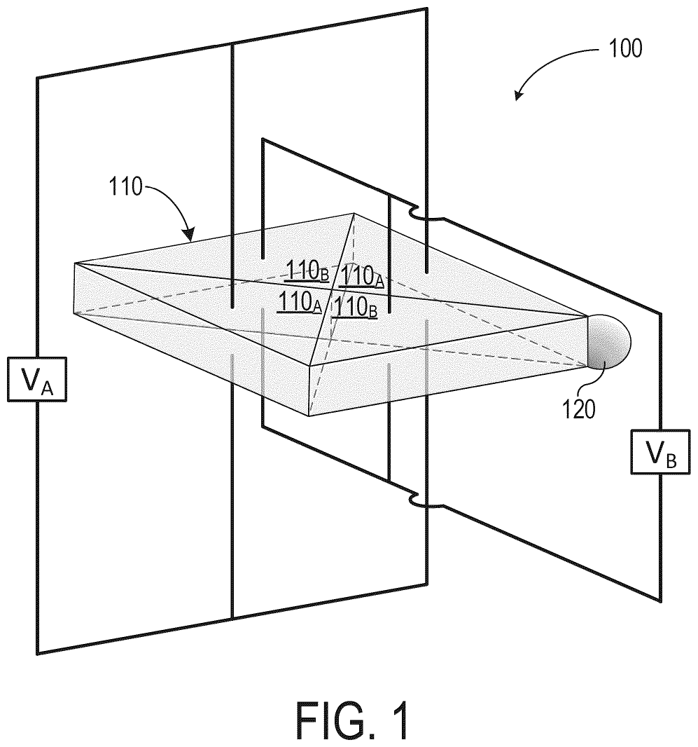

FIG. 1 is a perspective view of an example ultrasonic motor, in accordance with aspects of this disclosure. Ultrasonic motor 100 includes a piezoelectric component 110 and a protruding contact feature 120 coupled to piezoelectric component 110. Piezoelectric component 110 of ultrasonic motor 100 is divided into piezoelectric elements 110_{A} and 110_{B}. Each of piezoelectric elements 110_{A} and 110_{B} comprises two opposing triangular segments of piezoelectric component 110. That is, piezoelectric elements 110_{A} and 110_{B} of this example are identified as portions (e.g., hourglass-shaped portions) of a single piezoelectric mass of piezoelectric component 110. Other quantities, shapes, and arrangements of piezoelectric elements of piezoelectric component 110 are contemplated. In some examples, piezoelectric elements may be separate segments or discrete masses of piezoelectric material (e.g., adjacent or abutting piezoelectric masses) that comprise a piezoelectric component.

Piezoelectric elements 110_{A} and 110_{B} each include a piezoelectric material. Examples of piezoelectric materials include lead zirconate titanate (PZT), aluminum nitride (AlN), lead magnesium niobate-lead titanate (PMN-PT), sodium potassium niobate, polycrystalline zinc oxide (ZnO), sodium tungstate, some polymers such as polyvinylidene fluoride (PVDF), or other known, or future known, piezoelectric materials. In some examples, a piezoelectric material may include a composite (e.g., a polydimethylsiloxane (PDMS)/PZT composite).

Applying a voltage to a piezoelectric material may produce an electric field that induces a polarization in the piezoelectric material, causing the piezoelectric to expand or contract, depending on the directions of applied voltage, the produced electric fields, and the charge constant of the piezoelectric material. In the example of ultrasonic motor 100, voltages V_{A} and V_{B} are applied to piezoelectric elements 110_{A} and 110_{B}, respectively. Voltages V_{A} and V_{B} may, for examples, be applied to electrodes that are coupled to surfaces of piezoelectric elements 110_{A} and 110_{B}, respectively. Each of voltages V_{A} and V_{B} may induce polarization in the respective piezoelectric element 110_{A} and 110_{B} and may cause piezoelectric elements 110_{A} and 110_{B} to expand or contract. Applying each of driving voltages V_{A} and V_{B} as a time-dependent voltage waveform (e.g., a sine wave) may cause each of piezoelectric elements 110_{A} and 110_{B} to repeatedly expand and contract. Controlling the waveforms of driving voltages V_{A} and V_{B} (e.g., periods T, amplitudes, phase difference) and structuring the shape and arrangement of piezoelectric elements 110_{A} and 110_{B} may enable driving voltages V_{A} and V_{B} to manipulate the pattern of expansion and contraction of piezoelectric elements 110_{A} and 110_{B} to produce a controlled, periodic movement of piezoelectric component 110. Such manipulation of the movement of the respective piezoelectric elements 110_{A} and 110_{B} may enable an adjacent feature of piezoelectric motor 100, such as contact feature 120, to move in a periodic motion (e.g., an elliptical motion). Placing contact feature 120 in contact with a surface of a motor component such as a rotor or a linear track may enable the periodic expansion and contraction of piezoelectric elements 110_{A} and 110_{B} to induce a relative movement between piezoelectric component 110 and the motor component, thus enabling piezoelectric motor 110 to produce a controlled motion (e.g., rotation of a rotor, linear motion along a track).

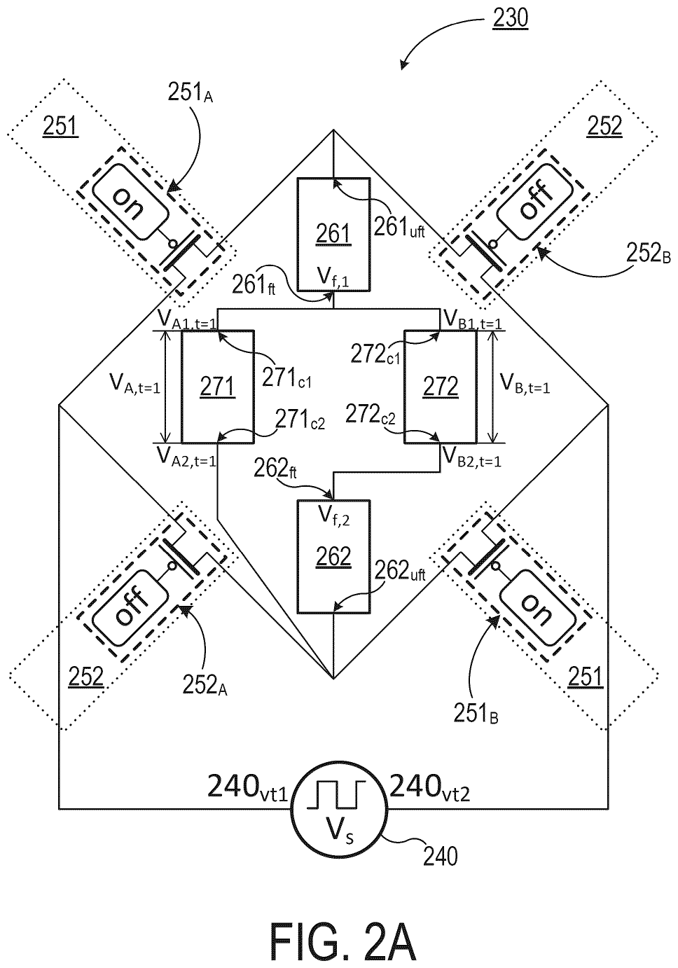

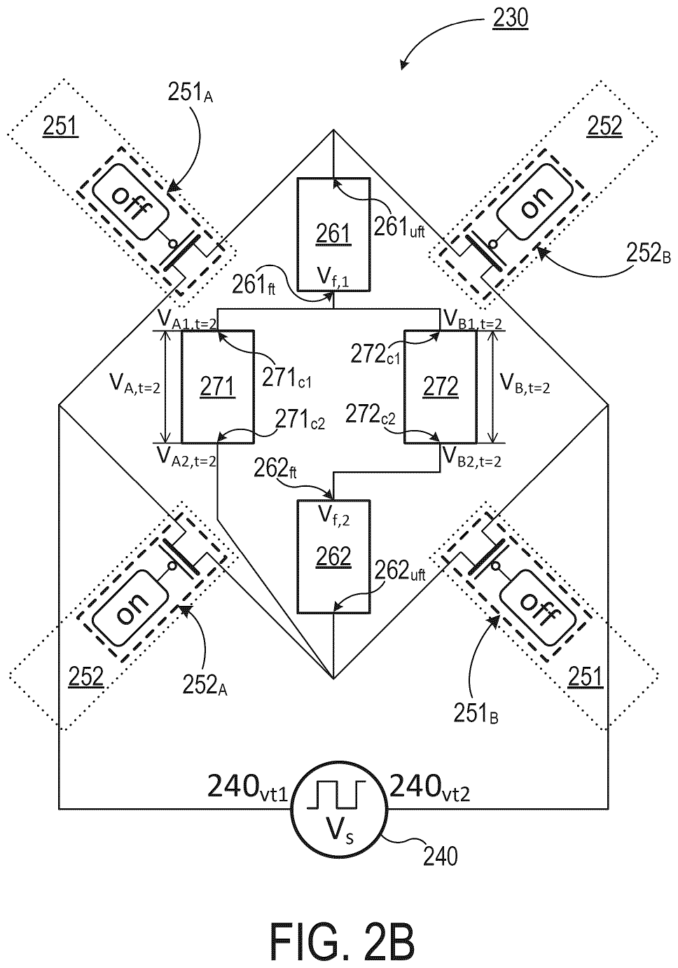

FIG. 2A is a circuit diagram illustrating an example drive circuit for an ultrasonic motor, in accordance with aspects of this disclosure. Drive circuit 230 includes a voltage source 240, a first set of switches 251_{A} and 251_{B} (hereafter, switches 251), a second set of switches 252_{A} and 252_{B} (hereafter, switches 252), a first filter 261, a second filter 262, a first piezoelectric element 271, and a second piezoelectric element 272. Drive circuit 230 is an example of a drive circuit that may be configured to drive ultrasonic motor 100 of FIG. 1. First piezoelectric element 271 and second piezoelectric element 272 may be examples for first piezoelectric element 110_{A} and piezoelectric 110_{B}, respectively, of piezoelectric component 110 of FIG. 1.

Voltage source 240 may be internal or external to a device that comprises drive circuit 230. For example, voltage source 240 may be an external AC source, or a component or circuit (e.g., and inverter circuit) that is configured to convert a DC voltage (e.g., from a battery, from an external DC source) to an AC voltage. Voltage source 240 is configured to apply a time-dependent source voltage V_{S} between first voltage source terminal 240ᵥₜ₁ and second voltage source terminal 240ᵥₜ₂. Time-dependent source voltage V_{S} comprises a source voltage waveform. In some examples, the source voltage waveform of source voltage V_{S} is a square waveform.

Examples of switches 251_{A}, 251_{B}, 252_{A}, and 252_{B} include solid state, semiconductor switches such as transistors (e.g., NPN and PNP bipolar transistors, MOSFETs, IGBTs), power diodes, silicon-controlled rectifiers (SCRs), DIACs and TRIACs, and gate turn-off thyristors (GTOs). Turning on a switch 251_{A}, 251_{B}, 252_{A}, and/or 252_{B} may include applying a voltage (e.g., to a gate of a switch that is a transistor) to enable current to flow through the respective switch. Turning off a switch 251_{A}, 251_{B}, 252_{A}, and/or 252_{B} may include ceasing to apply a voltage (e.g., to a gate of a switch that is a transistor) to reduce or disable current from flowing through the respective switch.

First filter 261 and second filter 262 are configured to filter high order harmonics from input voltage waveforms (e.g., a source voltage waveform of source voltage V_{S}). Examples of first filter 261 and second filter 262 include passive filters (e.g., resistor-capacitor filter, inductor-based filters) and active filters (e.g., op-amp based filters). In some examples, one or both of first filter 261 and second filter 262 are low-pass filters.

First filter 261 and second filter 262 each include an unfiltered terminal (261_{uft} and 262_{uft}, respectively) and a filtered terminal (261_{ft} and 262_{ft}, respectively). Filtered terminal 261_{ft} of first filter 261 is coupled to a first contact 271_{c1} of first piezoelectric element 271 and a first contact 272_{c1} of second piezoelectric element 272. Filtered terminal 262_{ft} of second filter 262 is coupled to a second contact 272_{c2} of second piezoelectric element 272.

In accordance with aspects of this disclosure, drive circuit 230 is configured to apply a driving voltage V_{A} to first piezoelectric element 271, and a driving voltage V_{B} to second piezoelectric element 272. In the example of FIG. 2A, driving voltages V_{A} and V_{B} are shown at a time t=1 (V_{A,t=1} and V_{B,t=1}, respectively). That is, the configuration of drive circuit 230 in FIG. 2A illustrates an instance of operation of drive circuit 230 at time t=1.

Driving voltage V_{A} at t=1 may be a first point of a driving voltage waveform that is applied to first piezoelectric element 271, and driving voltage V_{B} at t=1 may be a first point of a driving voltage waveform that is applied to second piezoelectric element 272. The driving voltage waveforms applied to first piezoelectric element 271 and second piezoelectric element 272 may be examples of the driving voltage waveforms applied to each of piezoelectric elements 110_{A} and 110_{B} as described in relation to FIG. 1

The configuration of drive circuit 230 at t=1 as illustrated in FIG. 2A is achieved by applying time-dependent source voltage V_{S} at voltage source 240, turning on first set of switches 251 (e.g., turning on switch 251_{A} and switch 251_{B}), and turning off second set of switches 252 (e.g., turning off switch 252_{A} and switch 252_{B}). This configuration couples first voltage source terminal 240ᵥₜ₁ to unfiltered terminal 261_{uft} of first filter 261 and couples second voltage source terminal 240ᵥₜ₂ to a second contact 271_{c2} of first piezoelectric element 271 and to unfiltered terminal 262_{uft} of second filter 262, producing a first filtered voltage V_{f,1} at filtered terminal 261_{ft} of first filter 261 and a second filtered voltage V_{f,2} at filtered terminal 262_{ft} second filter 262. Voltages V_{A1,t=1} and V_{A2,t=1} are produced at first contact 271_{c1} and second contact 271_{c2}, respectively, of first piezoelectric element 271, resulting in driving voltage V_{A,t=1}, where

$${V}_{A , t = 1} = {V}_{A 1 , t = 1} - {V}_{A 2 , t = 1}$$

Voltages V_{B1,t=1} and V_{B2,t=1} are produced at first contact 272_{c1} and second contact 272_{c2}, respectively, of second piezoelectric element 272, resulting in driving voltage V_{B,t=1}, where

$${V}_{B , t = 1} = {V}_{B 1 , t = 1} - {V}_{B 2 , t = 1}$$

FIG. 2B is a circuit diagram illustrating an example drive circuit for an ultrasonic motor, in accordance with aspects of this disclosure. FIG. 2B illustrates drive circuit 230 of FIG. 2A at a time t=2, with driving voltages V_{A} and V_{B} shown at time t=2 (V_{A,t=2} and V_{B,t=2}, respectively). That is, the configuration of drive circuit 230 in FIG. 2A illustrates a first instance of operation of drive circuit 230 at time t=1 and the configuration of drive circuit 230 in FIG. 2B illustrates a second instance of operation of drive circuit 230 at time t=2. Driving voltage V_{A} at t=2 may be a second point of the driving voltage waveform that is applied to first piezoelectric element 271, and driving voltage V_{B} at t=2 may be a second point of the driving voltage waveform that is applied to second piezoelectric element 272 (e.g., the driving voltage waveforms applied to first piezoelectric element 271 and second piezoelectric element 272 may be examples of the driving voltage waveforms applied to each of piezoelectric elements 110_{A} and 110_{B} as described in relation to FIG. 1).

The configuration of drive circuit 230 at t=2 as illustrated in FIG. 2B is achieved by applying time-dependent source voltage V_{S} at voltage source 240, turning off first set of switches 251 (e.g., turning off switch 251_{A} and switch 251_{B}), and turning on second set of switches 252 (e.g., turning on switch 252_{A} and switch 252_{B}). This configuration couples second voltage source terminal 240ᵥₜ₂ to unfiltered terminal 261_{uft} of first filter 261 and couples first voltage source terminal 240ᵥₜ₁ to second contact 271_{c2} of first piezoelectric element 271 and to unfiltered terminal 262_{uft} of second filter 262, producing a third filtered voltage V_{f,3} at filtered terminal 261_{ft} of first filter 261 and a fourth filtered voltage V_{f,4} at filtered terminal 262_{ft} second filter 262. Voltages V_{A1,t=2} and V_{A2,t=2} are produced at first contact 271_{c1} and second contact 271_{c2}, respectively, of first piezoelectric element 271, resulting in driving voltage V_{A,t=2}, where

$${V}_{A , t = 2} = {V}_{A 1 , t = 2} - {V}_{A 2 , t = 2}$$

Voltages V_{B1,t=2} and V_{B2,t=2} are produced at first contact 272_{c1} and second contact 272_{c2}, respectively, of second piezoelectric element 272, resulting in driving voltage V_{B,t=2}, where

$${V}_{B , t = 2} = {V}_{B 1 , t = 2} - {V}_{B 2 , t = 2}$$

FIGS. 2A and 2B illustrate two configurations of drive circuit 230. Specifically, FIGS. 2A and 2B illustrate two instances, at t=1 and t=2, respectively, of the application of a source voltage V_{S} and configurations of switches 251 and 252. Applying source voltage V_{S} as a time dependent source voltage waveform and repeatedly and periodically alternating the on and off states of switches 251 and 252 may culminate in the application of each of driving voltages V_{A} and V_{B} as a time-dependent voltage waveform to piezoelectric elements 271 and 272, respectively. Applying driving voltages V_{A} and V_{B} as time-dependent waveforms may enable to driving voltages V_{A} and V_{B} to manipulate the pattern of expansion and contraction of piezoelectric elements 271 and 272 to produce a controlled, periodic movement (e.g., of an adjacent contact feature, such as contact feature 120 of FIG. 1). That is, the components and design of drive circuit 230 as illustrated in FIGS. 2A and 2B enable a single drive circuit 230 to drive two piezoelectric elements (e.g., piezoelectric elements 271 and 272), potentially providing a cost benefit over drive circuits that require separate circuits to drive each piezoelectric element. Including first filter 261 and second filter 262 may remove high order harmonics, potentially producing purer driving voltage waveform (e.g., sine waveforms) and enabling better performance of an associated USM (e.g., USM of FIG. 1).

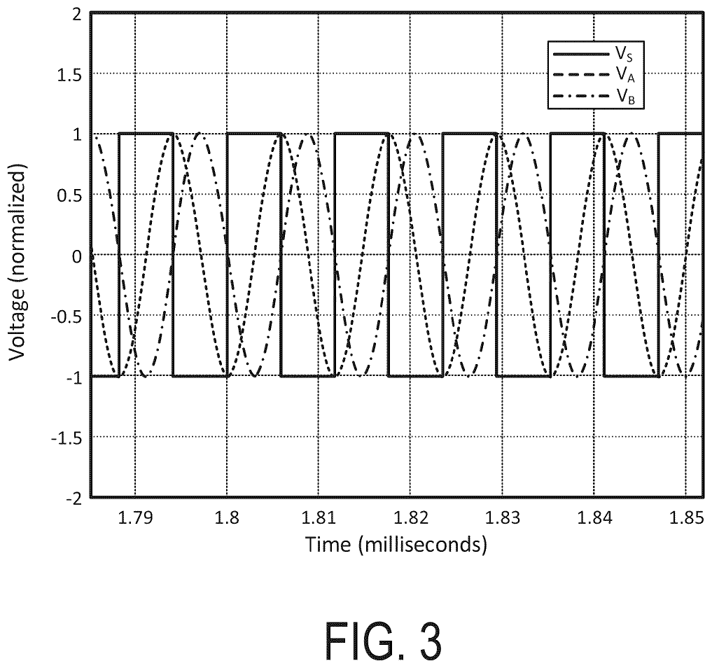

FIG. 3 is plot of a source voltage waveform and driving voltage waveforms of drive circuit for an ultrasonic motor, in accordance with aspects of this disclosure. V_{S} of FIG. 3 is one example of a source voltage waveform of source voltage V_{S} of FIGS. 2A and 2B. V_{A} and V_{B} of FIG. 3 are examples of driving voltage waveforms of driving voltages V_{A} and V_{B} of FIGS. 2A and 2B. V_{S}, V_{A}, and V_{B} of FIG. 3 are expressed as normalized voltage versus time.

V_{S} of FIG. 3 is a square waveform having a frequency:

ω=2πf

Frequency ω of V_{S} may be tuned to a resonance frequency of a piezoelectric material of piezoelectric elements 271 and 272. Voltages produced at the contacts of piezoelectric elements 271 and 272 of FIGS. 2A and 2B (contacts 271_{c1}, 271_{c2}, 272_{c1}, and 272_{c2} may be modeled as:

$${V}_{A 1} = {V}_{S} u ( sin ( 2 π ft ) ) \\ {V}_{A 2} = {V}_{S} u ( sin ( 2 π ft - π ) ) = {V}_{S} u ( - sin ( 2 π ft ) ) \\ {V}_{B 1} = {V}_{S} u ( sin ( 2 π ft + φ ) ) \\ {V}_{B 2} = {V}_{S} u ( sin ( ( 2 π ft + φ ) - π ) ) = {V}_{S} u ( - sin ( 2 π ft + φ ) )$$

where u is the step function:

$$u ( x ) = \{ \begin{matrix}1 & for x > 0 \\ 0 & for x \leq 0\end{matrix}$$

indicating the configuration of switches 251 and 252, and where φ indicates a phase difference between V_{A} and V_{B} . In some examples, φ is about 90 degrees. The difference between the voltages at the first contact and the second contact of each of first piezoelectric element 271 and second piezoelectric element 272 can be expressed as:

$${V}_{A 1} - {V}_{A 2} = {V}_{S} [ u ( sin ( 2 π ft ) ) - u ( - sin ( 2 π ft ) ) ] = {V}_{S} [ sgn ( sin ( 2 π ft ) ) ] \\ {V}_{B 1} - {V}_{B 2} = {V}_{S} [ u ( sin ( 2 π ft + φ ) ) - u ( - sin ( 2 π ft + φ ) ) ] = {V}_{S} [ sgn ( sin ( 2 π ft + φ ) ) ] \\ where \\ sgn ( x ) = \{ \begin{matrix}1 for x > 0 \\ 0 for x = 0 \\ - 1 for x < 0\end{matrix}$$

V_{A1}-V_{A2} can be expressed as a Fourier series:

$$\begin{matrix}{V}_{A 1} - {V}_{A 2} = {V}_{S} [ sgn ( sin ( 2 π ft ) ) ] \\ = {V}_{S} \frac{4}{π} {\sum }_{k = 1}^{∞} \frac{sin ( 2 π ( sk - 1 ) ft )}{2 k - 1} \\ = {V}_{S} \frac{4}{π} [ sin ( ω t ) + \frac{1}{3} sin ( 3 ω t ) + \frac{1}{5} sin ( 5 ω t ) + … ]\end{matrix}$$

Similarly, V_{B1}-V_{B2} can be expressed as a Fourier series:

$$\begin{matrix}{V}_{B 1} - {V}_{B 2} = {V}_{S} [ sgn ( sin ( 2 π ft + φ ) ) ] \\ = {V}_{S} \frac{4}{π} [ sin ( ω t + φ ) + \frac{1}{3} sin ( 3 ω t + φ ) + \frac{1}{5} sin ( 5 ω t + φ ) + … ]\end{matrix}$$

In examples where first filter 261 and second filter 262 are low pass filters, the higher order harmonics of V_{A1}-V_{A2} and V_{B1}-V_{B2} (3ωt, 5ωt, etc.) may be filtered out, reducing the square waveforms of V_{A1}-V_{A2} and V_{B1}-V_{B2} to driving voltage waveforms V_{A} and V_{B} that have the form of sine waveforms:

$${V}_{A} = {V}_{A 1} - {V}_{A 2} ∝ {V}_{S} sin ( 2 π ft ) \\ {V}_{B} = {V}_{B 1} - {V}_{B 2} ∝ {V}_{S} sin ( 2 π ft + φ )$$

as illustrated in FIG. 3.

A 90-degree phase shift φ between driving voltage waveforms V_{A} and V_{B} results from the function and configuration of first filter 261 and second filter 262. In another form, driving voltage waveforms V_{A} and V_{B} may be expressed as functions of terms F_{A} and F_{B} representing first filter 261 and second filter 262, respectively:

$${V}_{A} = {V}_{S} {F}_{A} [ sgn ( sin ( 2 π ft ) ) ] \\ {V}_{B} = {V}_{S} {F}_{B} [ {F}_{A} [ sgn ( sin ( 2 π ft ) ) ] ]$$

where the functions F_{A} and F_{B} for first filter 261 and second filter 262 are

$${F}_{A} = {F}_{B} = \frac{{ω}_{N}^{2}}{{s}^{2} + 2 {ζω}_{N} s + {ω}_{N}^{2}} , {ω}_{N} = 2 π f$$

The input of second filter 262 is a sine wave having a frequency f. The frequency response of second filter 262 is thus:

$${\frac{{ω}_{N}^{2}}{{s}^{2} + 2 {ζω}_{N} s + {ω}_{N}^{2}} \vert}_{s = j {ω}_{N}} = \frac{1}{2 ζ} {e}^{- j \frac{π}{2}}$$

giving a 90-degree phase shift between driving voltage waveforms V_{A} and V_{B} .

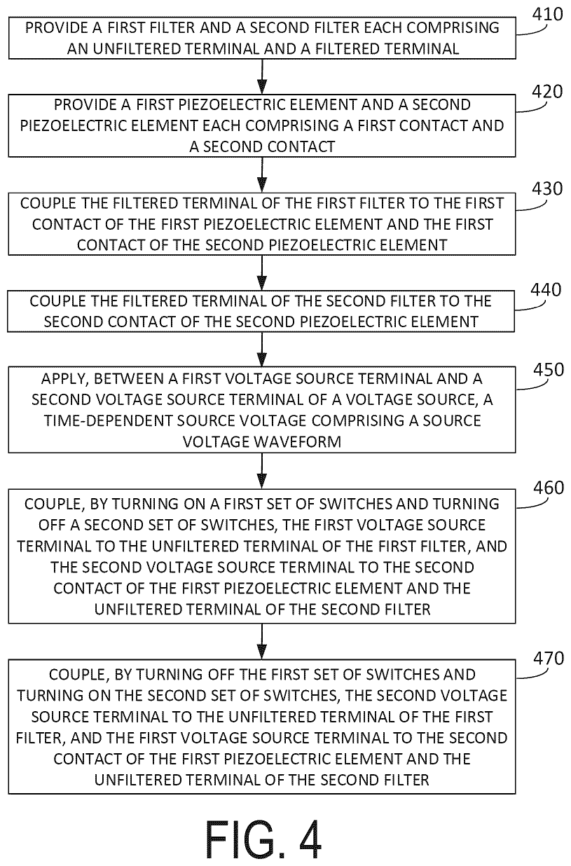

FIG. 4 is a flow diagram illustrating a method for driving an ultrasonic motor, in accordance with aspects of this disclosure. The method of FIG. 4 may be described with reference to drive circuit 230 of FIGS. 2A and 2B.

In accordance with aspects of this disclosure, a method for driving an ultrasonic motor includes the steps of providing a first filter and a second filter each comprising an unfiltered terminal and a filtered terminal (410); providing a first piezoelectric element and a second piezoelectric element each comprising a first contact and a second contact (420); coupling the filtered terminal of the first filter to the first contact of the first piezoelectric element and the first contact of the second piezoelectric element (430); coupling the filtered terminal of the second filter to the second contact of the second piezoelectric element (440); applying, between a first voltage source terminal and a second voltage source terminal of a voltage source, a time-dependent source voltage comprising a source voltage waveform (450); coupling, by turning on a first set of switches and turning off a second set of switches, the first voltage source terminal to the unfiltered terminal of the first filter, and the second voltage source terminal to the second contact of the first piezoelectric element and the unfiltered terminal of the second filter (460); coupling, by turning off the first set of switches and turning on the second set of switches, the second voltage source terminal to the unfiltered terminal of the first filter, and the first voltage source terminal to the second contact of the first piezoelectric element and the unfiltered terminal of the second filter (470).

The first filter and second filter may refer to first filter 261 and second filter 262, respectively, of FIGS. 2A and 2B. The first piezoelectric element and second piezoelectric element may refer to first piezoelectric element 271 and second piezoelectric element 272, respectively, of FIGS. 2A and 2B. The voltage source may refer to voltage source 240 of FIGS. 2A and 2B. The first set of switches and second set of switches may refer to switches 251 and 252, respectively, of FIGS. 2A and 2B. The source voltage waveform of step 450 may be a square waveform (e.g., source voltage waveform V_{S} of FIG. 3).

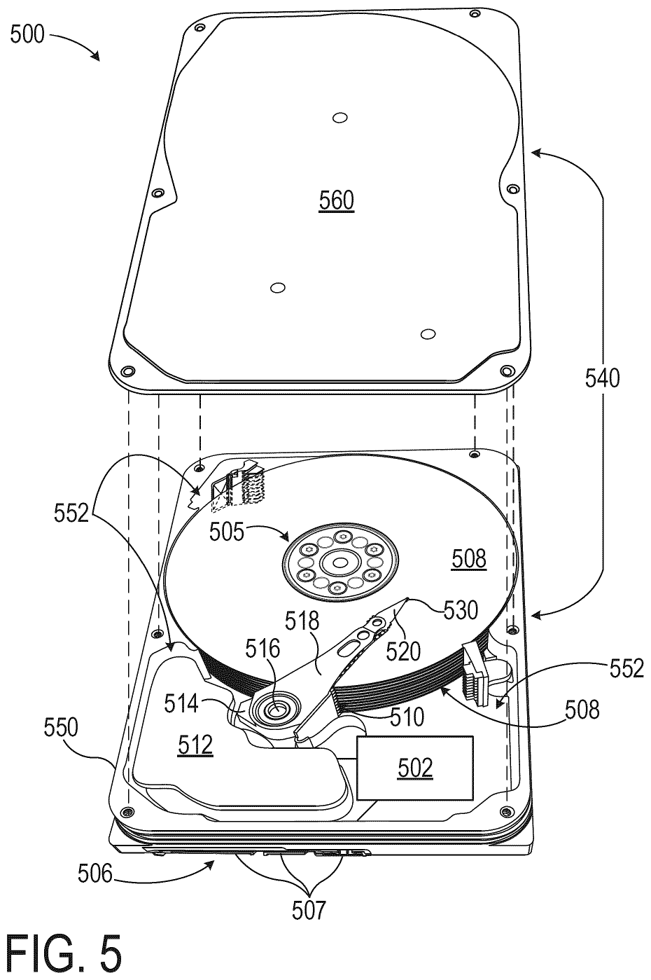

FIG. 5 is a perspective view of an example hard disk drive, in accordance with aspects of this disclosure. In accordance with aspects of this disclosure, HDD 500 may include one or more ultrasonic motors (e.g., ultrasonic motor 100 of FIG. 1) that may be driven by the example drive circuits and methods of this disclosure. Some examples are described hereafter but are not considered to be limiting to the scope of applications in an HDD that may utilize the example drive circuits and methods of this disclosure.

HDD 500 includes an enclosure 540 configured to contain components of HDD 500. Enclosure 540 includes a base 550 and a top cover 560. Base 550 includes a recess 552 to accommodate components of HDD 500. HDD 500 further includes a printed circuit board assembly (PCBA) 506. PCBA 506 of this example is coupled to base 550 and includes a plurality of input/output connectors 507 that are each configured to provide an interface between one or more components of HDD 500 and one or more host devices (e.g., a computer, a server, a consumer electronic device, etc.). HDD 500 may include a drive controller 502 that is configured to control components and drive operations of HDD 500 by receiving commands (e.g., read commands and write commands) from the host device(s). Examples of drive controller 502 include a digital signal processor (DSP), a processor or microprocessor, an application specific integrated circuit (ASIC), a field programmable gate array (FPGA), and a system on a chip (SoC), among others. While illustrated as a single controller, the functionality of drive controller 502 may in some examples be performed by a combination of controllers. Drive circuit 230 of FIGS. 2A and 2B, or another example drive circuit in accordance with aspects of this disclosure, may be disposed on PCBA 506, included in drive 502, or may be included in other circuitry or controller of HDD 500.

Base 550 may be formed from any suitable material, such as metal (e.g., aluminum), plastic, or other suitable material or combinations thereof. In some examples, base 550 comprises multiple components, such as an outer frame and a bottom cover, that are coupled together (e.g., by screws, by welding). Top cover 560 is configured to couple to base 550 to enclose components of HDD 500. Top cover 560 can be coupled to base 550 using any suitable technique, such as using one or more screws, connection fingers, locking/clipping structures, adhesives, rivets, other mechanical fasteners, welding (e.g., ultrasonic welding) or combinations thereof. Components other than those illustrated or specifically identified in FIG. 5 and described herein are contemplated and may be enclosed by base 550 and top cover 560.

HDD 500 includes a head stack assembly (HSA) 510 and one or more magnetic disks 508 configured to store bits of data. HSA 510 includes a plurality of head gimbal assemblies (HGA) 520. Each HGA 520 includes a magnetic recording head 530. Each magnetic recording head 530 is configured to read data from and write data to a surface of a magnetic disk 508. Each magnetic recording head 530 includes a reader and a writer. Other components of a magnetic recording head 530 (e.g., heaters, heat sinks, piezoelectric actuators) are contemplated. HDD 500 of FIG. 5 may be a heat-assisted magnetic recording (HAMR) HDD. In the example of a HAMR HDD, a magnetic recording head 530 may be a heat-assisted magnetic recording (HAMR) head and may include a light source such as a laser, a waveguide, and a near-field transducer (NFT) that is configured to heat and lower the coercivity of magnetic grains in a spot of focus on a magnetic disk 508.

A motor assembly 505 is configured to rotatably support magnetic disks 508 and circumferentially rotate magnetic disks 508 about an axis of rotation during operations of HDD 500. Magnetic disks 508 are mounted on motor assembly 505 such that an annular volume of each magnetic disk 508 encircles a portion of motor assembly 505. Motor assembly 505 may rotate magnetic disks 508 during an operation of HDD 500 such that each magnetic disk 508 moves relative to a respective magnetic recording head 530 to enable the magnetic recording head 530 to read data from and/or write data to the magnetic disk 508. In some examples, a USM may be used to rotate motor assembly 505. In such examples, drive circuit 230 of FIGS. 2A and 2B and/or the methods of FIG. 4 may be used to drive the USM of motor assembly 505.

A mechanism 512 causes a hub 514 to rotate about a shaft 516 in either rotational direction. Rotatable drive actuator arms 518 are mechanically coupled to hub 514 and to each HGA 520 such that hub 514 causes rotatable drive actuator arms 518 and HGAs 520, and thus magnetic recording heads 530, to move relative to magnetic disks 508. Examples of mechanism 512 and hub 514 include a voice coil drive actuator, a voice coil motor (VCM), and an ultrasonic motor (USM). In examples where mechanism 512 includes a USM in contact with hub 514, or in alternative examples where hub 514 is replaced by another means of mounting and moving HGAs 520 (e.g., a linear track), drive circuit 230 of FIGS. 2A and 2B and/or the methods of FIG. 4 may be used to drive the USM of mechanism 512.

Various examples have been presented for the purposes of illustration and description. These and other examples are within the scope of the following claims.

What is claimed is:

1. A device comprising:
a first set of switches and a second set of switches;
a first filter and a second filter each comprising an unfiltered terminal and a filtered terminal; and
a first piezoelectric element and a second piezoelectric element each comprising a first contact and a second contact,
wherein the filtered terminal of the first filter is coupled to the first contact of the first piezoelectric element and the first contact of the second piezoelectric element,
wherein the filtered terminal of the second filter is coupled to the second contact of the second piezoelectric element, and
wherein turning on the first set of switches and turning off the second set of switches:
couples a first voltage source terminal of a voltage source to the unfiltered terminal of the first filter,
produces a first filtered voltage at the filtered terminal of the first filter,
couples a second voltage source terminal of the voltage source to the second contact of the first piezoelectric element and to the unfiltered terminal of the second filter,
produces a second filtered voltage at the filtered terminal of the second filter,
applies a first driving voltage to the first piezoelectric element, and
applies a second driving voltage to the second piezoelectric element.

2. The device of claim 1, wherein turning off the first set of switches and turning on the second set of switches:
couples the second voltage source terminal to the unfiltered terminal of the first filter,
produces a third filtered voltage at the filtered terminal of the first filter,
couples the first voltage source terminal to the second contact of the first piezoelectric element and to the unfiltered terminal of the second filter,
produces a fourth filtered voltage at the filtered terminal of the second filter,
applies a third driving voltage to the first piezoelectric element, and
applies a fourth driving voltage to the second piezoelectric element.

3. The device of claim 2, wherein the voltage source applies a time-dependent source voltage between the first voltage source terminal and the second voltage source terminal, the time-dependent source voltage comprising a source voltage waveform.

4. The device of claim 3, wherein the source voltage waveform is a square waveform.

5. The device of claim 2,
wherein the first driving voltage applied to the first piezoelectric element comprises a first point of a driving voltage waveform that is applied to the first piezoelectric element, and
wherein the third driving voltage applied to the first piezoelectric element comprises a second point of the driving voltage waveform that is applied to the first piezoelectric element.

6. The device of claim 5,
wherein the driving voltage waveform that is applied to the first piezoelectric element is a first driving voltage waveform,
wherein the second driving voltage applied to the second piezoelectric element comprises a first point of a second driving voltage waveform that is applied to the second piezoelectric element, and
wherein the fourth driving voltage applied to the second piezoelectric element comprises a second point of the second driving voltage waveform that is applied to the second piezoelectric element.

7. The device of claim 6,
wherein the first driving voltage waveform that is applied to the first piezoelectric element has a form of a first sine wave, and
wherein the second driving voltage waveform that is applied to the second piezoelectric element has a form of a second sine wave that is out of phase with the first sine wave.

8. The device of claim 7, wherein the second sine wave is out of phase with the first sine wave by about 90 degrees.

9. The device of claim 2, wherein at least one of the first filter and the second filter is a low-pass filter.

10. The device of claim 2,
wherein each of the first set of switches and the second set of switches comprises a first switch and a second switch,
wherein turning on the first set of switches comprises turning on the first switch and the second switch of the first set of switches,
wherein turning off the first set of switches comprises turning off the first switch and the second switch of the first set of switches,
wherein turning on the second set of switches comprises turning on the first switch and the second switch of the second set of switches, and
wherein turning off the second set of switches comprises turning off the first switch and the second switch of the second set of switches.

11. A drive circuit for an ultrasonic motor, the drive circuit comprising:
a first set of switches and a second set of switches;
a first filter and a second filter each comprising an unfiltered terminal and a filtered terminal; and
a first piezoelectric element and a second piezoelectric element each comprising a first contact and a second contact,
wherein the filtered terminal of the first filter is coupled to the first contact of the first piezoelectric element and the first contact of the second piezoelectric element,
wherein the filtered terminal of the second filter is coupled to the second contact of the second piezoelectric element, and
wherein turning on the first set of switches and turning off the second set of switches:
couples a first voltage source terminal of a voltage source to the unfiltered terminal of the first filter,
produces a first filtered voltage at the filtered terminal of the first filter,
couples a second voltage source terminal of the voltage source to the second contact of the first piezoelectric element and to the unfiltered terminal of the second filter,
produces a second filtered voltage at the filtered terminal of the second filter,
applies a first driving voltage to the first piezoelectric element, and
applies a second driving voltage to the second piezoelectric element.

12. The drive circuit of claim 11, wherein turning off the first set of switches and turning on the second set of switches:
couples the second voltage source terminal to the unfiltered terminal of the first filter,
produces a third filtered voltage at the filtered terminal of the first filter,
couples the first voltage source terminal to the second contact of the first piezoelectric element and to the unfiltered terminal of the second filter,
produces a fourth filtered voltage at the filtered terminal of the second filter,
applies a third driving voltage to the first piezoelectric element, and
applies a fourth driving voltage to the second piezoelectric element.

13. The drive circuit of claim 12, wherein the voltage source applies a time-dependent source voltage between the first voltage source terminal and the second voltage source terminal, the time-dependent source voltage comprising a source voltage waveform.

14. The drive circuit of claim 13, wherein the source voltage waveform is a square waveform.

15. The drive circuit of claim 12,
wherein the first driving voltage applied to the first piezoelectric element comprises a first point of a driving voltage waveform that is applied to the first piezoelectric element, and
wherein the third driving voltage applied to the first piezoelectric element comprises a second point of the driving voltage waveform that is applied to the first piezoelectric element.

16. The drive circuit of claim 15,
wherein the driving voltage waveform that is applied to the first piezoelectric element is a first driving voltage waveform,
wherein the second driving voltage applied to the second piezoelectric element comprises a first point of a second driving voltage waveform that is applied to the second piezoelectric element, and
wherein the fourth driving voltage applied to the second piezoelectric element comprises a second point of the second driving voltage waveform that is applied to the second piezoelectric element.

17. The drive circuit of claim 16,
wherein the first driving voltage waveform that is applied to the first piezoelectric element has a form of a first sine wave, and
wherein the second driving voltage waveform that is applied to the second piezoelectric element has a form of a second sine wave that is out of phase with the first sine wave.

18. A method comprising the steps of:
coupling a filtered terminal of a first filter to a first contact of a first piezoelectric element and a first contact of a second piezoelectric element;
coupling a filtered terminal of a second filter to a second contact of the second piezoelectric element;
applying, between a first voltage source terminal and a second voltage source terminal of a voltage source, a time-dependent source voltage comprising a source voltage waveform; and
coupling, by turning on a first set of switches and turning off a second set of switches, the first voltage source terminal to an unfiltered terminal of the first filter, and the second voltage source terminal to a second contact of the first piezoelectric element and to an unfiltered terminal of the second filter.

19. The method of claim 18, further comprising the step of coupling, by turning off the first set of switches and turning on the second set of switches, the second voltage source terminal to the unfiltered terminal of the first filter, and the first voltage source terminal to the second contact of the first piezoelectric element and to the unfiltered terminal of the second filter.

20. The method of claim 19, wherein the source voltage waveform is a square waveform.
